(19) United States
(12) Patent Application Publication
(10) Pub. No.: US 2024/0279027 A1
(43) Pub. Date: Aug. 22, 2024

(54) METHOD FOR ADAPTING A COUNTERWEIGHT OF AN ELEVATOR SYSTEM

(71) Applicant: Inventio AG, Hergiswil (CH)

(72) Inventor: Thomas Eilinger, Küssnacht am Rigi (CH)

(21) Appl. No.: 18/571,283

(22) PCT Filed: Jun. 24, 2022
(86) PCT No.: PCT/EP2022/067302

§ 371 Date: Dec. 18, 2023

(30) Foreign Application Priority Data
Jun. 25, 2021 (EP) 21181784.6

(51) Int. Cl. B66B 19/00; B66B 9/00; B66B 17/12

(52) U.S. Cl. CPC B66B 19/00; B66B 9/00; B66B 17/12

(57) ABSTRACT

A method for adapting an elevator system counterweight coupled to an elevator car involves: generating electric motor control commands to move the car from first to second positions in first and third test runs and from the second to first positions in second and fourth test runs, the car being loaded with a weight only in the third and fourth test runs; receiving during the car movement motor current flow measurement data and car height measurement data relative to the first and/or second positions in successive time steps in each test run; calculating at least one calibration function parameter defining a relationship between the current, the height and the weight using the current and height measurement data in the to obtain at least one calibration value; and calculating an adaptation value for adapting the counterweight to be in equilibrium with the car using the at least one calibration value.

### FIELD

The present invention relates to a method for adapting a counterweight of an elevator system. Furthermore, the invention relates to a control device, a computer program and to a computer-readable medium for carrying out such a method. The invention also relates to an elevator system equipped with such a control device.

### BACKGROUND

An elevator system, such as a passenger or freight elevator, generally comprises a counterweight, which is connected to an elevator car via suitable suspension means and serves to reduce the forces required for raising or lowering the elevator car.

The counterweight and the elevator car should be in equilibrium with one another when the elevator car is loaded with a certain weight. In order to produce this state of equilibrium, weight can be progressively added to or removed from the loaded elevator car, for example, by means of compensating weights until it is in equilibrium with the counterweight, i.e., it no longer moves when the elevator car brake is released. The counterweight can then be adapted according to the compensating weights that are added or removed. Such a step-by-step approach to the correct counterweight can be very time-consuming. In addition, the result can be imprecise due to different frictional conditions when raising and lowering the elevator car.

### SUMMARY

There may therefore be a need for a simplified method for adapting a counterweight of an elevator system. In particular, there may be a need for a method by means of which an accurate weight amount can be calculated, by which the counterweight can be made heavier or lighter in order to get the counterweight in equilibrium with the (loaded) elevator car without having to perform several attempts beforehand using different compensating weights. Furthermore, there may be a need for a control device, a computer program product and a computer-readable medium for performing such a method as well as for an elevator system equipped with such a control device.

Such a need can be met by the subject matter of advantageous embodiments that are defined in the following description.

A first aspect of the invention relates to a method for adapting a counterweight of an elevator system. The elevator system comprises an elevator shaft, an elevator car, which is movable along the elevator shaft at least between a first position and a second position and is coupled to the counterweight via suspension means, and an electric motor for driving the elevator car. The method comprises at least the following steps: generating control commands for controlling the electric motor so that the elevator car performs at least one first, second, third and fourth test run, wherein the elevator car in each of the first and third test runs is moved from the first position to the second position and in each of the second and fourth test runs from the second position to the first position, wherein the elevator car is loaded in the third and fourth test runs with a weight and is not loaded with the weight in the first and second test runs; receiving current measurement data, which indicate a current measured by means of a current measuring device when the elevator car moves, which current flows through the electric motor, and height measurement data, which indicate a height of the elevator car, which is measured by means of a height measuring device when the elevator car moves and relates to the first and/or second position in a plurality of successive time steps in each test run; calculating at least one parameter of a calibration function that defines a relationship between the current, the height and the weight using the current measurement data and the height measurement data that were received in different test runs in order to obtain at least one calibration value; and using the at least one calibration value to calculate an adaptation value by which the counterweight is to be adapted so that the counterweight is in equilibrium with the elevator car.

The method can, for example, be automatically carried out by a processor of the control device of the elevator system.

The first and second positions can be positions of different height of the elevator car in the elevator shaft. For example, the first position can be the highest position of the elevator car and the second position can be the lowest position of the elevator car, or vice versa.

For calculating the at least one parameter of the calibration function, for example, only those current measurement data and/or only those height measurement data can be used that were generated and/or received in a period of time in which the speed of the elevator car is detected as being constant. This can be the case, for example, when it is detected by evaluating the height measurement data, for example, that the elevator car moves within a specific height range between the first and second positions.

The electric motor can be controlled, for example, in such a way that the elevator car is moved non-stop in each test run either from the first position to the second position or from the second position to the first position according to a predetermined speed profile. The speed profile may comprise, for example, a continuously increasing portion, a constant portion and a continuously decreasing portion. In this case, the constant portion can, on the one hand, transition directly into the continuously increasing portion and, on the other hand, directly into the continuously decreasing portion.

It is possible for the current measuring device to generate the current measurement data in a plurality of successive time steps in each test run and transmit it to the control device. It is also possible for the height measuring device to generate the height measurement data in a plurality of successive time steps in each test run and transmit it to the control device. In this case, the current measurement data and the height measurement data can be temporally correlated to one another. For example, the same time stamp can be assigned to the current measurement data and the height measurement data, which are temporally correlated to one another.

The current measuring device can be, for example, a component of a current regulator for regulating a current flow through the electric motor. In this case, the controller can be configured to control circuit breakers of a converter, which is connected at its output to terminals of the electric motor, using the current measurement data.

The height measuring device can comprise, for example, a position sensor in the form of an absolute encoder or incremental encoder. Additionally or alternatively, the height measuring device may comprise a barometer. Alternatively or in addition to such a direct measurement, the height of the elevator car can also be determined from an acceleration of the elevator car, a rotational speed or an angle of rotation of the electric motor.

“Calibration function” can be understood to mean a mathematical function, for example a linear function, or else a polynomial of second or higher degree. The parameter or parameters of the calibration function can be calculated, for example, by processing the current measurement data and the height measurement data in a regression method. The current measurement data and the height measurement data generated and/or received in all four test runs can be processed. As already mentioned, only those current measurement data and/or only those height measurement data of each test run can be processed that were generated and/or received within a certain period of time during the respective test runs in which the speed of the elevator car was detected as being constant.

The current may, for example, be a dependent variable of the calibration function, wherein the height and the weight can be independent variables of the calibration function.

“Current” may also be understood to mean a current component, for example a d-component or q-component of the current.

“Calibration value” may be understood to mean a parameter value assigned to a single parameter of the calibration function.

The adaptation value can be calculated, for example, by processing the calibration value or values, taking into account a height difference that is measured (for example during a programming run) between the first and second positions and/or taking into account a permissible weight for which the elevator car is designed or with which the elevator car may be loaded at maximum. The allowable weight may also be referred to as a nominal load or payload. In addition, in the calculation of the adaptation value, a weighting factor may be taken into account that indicates a desired ratio of the counterweight to the permissible weight in the balanced state of the elevator system. The adaptation value can be signed. For example, a negative adaptation value may mean that a current mass of the counterweight is to be reduced by the amount of the adaptation value.

It is possible for the adaptation value to be displayed in an additional step via a display device, for example in the form of a monitor. The display device can be, for example, a component of the control device or a component of an external data processing device that can be coupled to the control device via a wireless or wired data communication connection. Such an external data processing device can be implemented, for example, as a PC, laptop, smartphone or tablet.

In brief, the method described here and below enables a significantly simpler and more accurate determination, compared to conventional test methods, of the correct counterweight. In particular, a simple and accurate determination of a compensating weight to be added to or taken away from the counterweight is made possible without this compensating weight having to be determined by trial and error.

In this case, measurement inaccuracies due to friction fluctuations can be minimized. This can be achieved, for example, by measurement results from measurements being averaged in a suitable manner during a phase in which the elevator car is traveling at (approximately) constant speed, whereby measurement noise and measurement deviations due to friction fluctuations are effectively filtered out as a function of the travel path.

It is particularly advantageous that the method can be carried out again after the first calculation of the calibration value or values without the elevator car having to be loaded again for this purpose with a suitable weight. This considerably reduces the effort during regular testing of the counterweight balance, because weights for increasing the weight of the elevator car no longer need to be transported to the installation location of the elevator system.

Ultimately, the method described here and below enables a very precise adjustment of a pretensioning torque to be generated by means of the electric motor. Undesired movements of the elevator car when the elevator car brake is released can be avoided by a correctly adjusted pretensioning torque.

A second aspect of the invention relates to a control device having a processor, which is configured to carry out the method according to one embodiment of the first aspect of the invention. The control device may comprise hardware and/or software modules. In addition to the processor, the control device may comprise a memory and data communication interfaces for data communication with peripheral devices. Features of the method according to one embodiment of the first aspect of the invention may also be features of the control device, and vice versa.

A third aspect of the invention relates to an elevator system, for example a freight or passenger elevator. The elevator system comprises an elevator shaft, an elevator car, which is movable along the elevator shaft at least between a first position and a second position, a counterweight, which is coupled to the elevator car via suspension means, an electric motor for driving the elevator car, a current measuring device for measuring a current flowing through the electric motor, a height measuring device for measuring a height of the elevator car relating to the first and/or second position and a control device according to one embodiment of the second aspect of the invention.

A fourth aspect of the invention relates to a computer program, which comprises commands that prompt a processor to carry out the method according to one embodiment of the first aspect of the invention when the computer program is executed by the processor.

A fifth aspect of the invention relates to a computer-readable medium on which the computer program according to one embodiment of the fourth aspect of the invention is stored. The computer-readable medium can be a volatile or non-volatile data memory. For example, the computer-readable medium may be a hard disk, a USB memory device, a RAM, ROM, EPROM, or flash memory. The computer-readable medium can also be a data communication network that enables a program code to be downloaded, such as the Internet or a data cloud.

Features of the method according to an embodiment of the first aspect of the invention can also be features of the computer program and/or of the computer-readable medium, and vice versa.

Possible features and advantages of embodiments of the invention can be regarded, inter alia and without limiting the invention, as being based upon the concepts and findings described below.

According to one embodiment, a height reference value can be calculated by halving a height difference between the first and second position. Additionally or alternatively, a weight reference value can be calculated by multiplying a permissible mass of the weight by a predetermined weighting factor. In this case, the adaptation value may further be calculated using the height reference value, the weight reference value or a combination of the height reference value and the weight reference value.

The height difference may, for example, have been measured in a programming run of the elevator car preceding the method. The height difference may correspond to an actual length of a distance that the elevator car can travel when moving from the first position to the second position, or vice versa. In the balanced state, the elevator car and the counterweight should remain at the same height, i.e. at half the height between the first and second positions, when the elevator car brake is released. The weighting factor can indicate a predetermined ratio of the counterweight to the nominal load, i.e. to the permissible mass of the weight, in the balanced state.

According to one embodiment, a first average function defining a first relationship between the current and the height, while assuming ideal friction conditions, can be determined using the current measurement data and the height measurement data that were received in the first and second test runs. Additionally or alternatively, a second average function defining a second relationship between the current and the height, while assuming ideal friction conditions, may be determined using the current measurement data and the height measurement data received in the third and fourth test runs. In this case, the at least one parameter of the calibration function may be calculated using the first average function and/or the second average function. The term “ideal friction conditions” can be understood to mean identical frictional conditions when the elevator car moves in both directions. The first average function and/or the second average function can be, for example, a linear function and/or a function obtained by linear regression. In this way, the parameter or parameters of the calibration function can be calculated with little computing effort.

According to one embodiment an output function that defines a linear relationship between the current and the height may be determined for each test run by processing the current measurement data and the height measurement data received in different time steps in the relevant test run. In this case, at least one parameter of the first average function may be calculated by forming a mean value from a parameter of the output function for the first test run and a parameter of the output function for the second test run. Additionally or alternatively, at least one parameter of the second average function may be calculated by forming a mean value from a parameter of the output function for the third test run and a parameter of the output function for the fourth test run. In this way, the computing effort involved in calculating the parameter or parameters of the calibration function can be further reduced.

The output function may comprise, for example, at least one first parameter and one second parameter.

In this case, it is possible for a first parameter of the first average function to be determined by forming a mean value from the first parameter of the output function for the first test run and the first parameter of the output function for the second test run. Similarly, a second parameter of the first average function may be determined by forming a mean value from the second parameter of the output function for the first test run and the second parameter of the output function for the second test run.

Additionally or alternatively, it is possible in this case for a first parameter of the second average function to be determined by forming a mean value from the first parameter of the output function for the third test run and the first parameter of the output function for the fourth test run. Similarly, a second parameter of the second average function may be determined by forming a mean value from the second parameter of the output function for the third test run and the second parameter of the output function for the fourth test run.

According to one embodiment, a first current value may be calculated by inputting the height reference value into the first average function. Additionally or alternatively, a second current value may be calculated by inputting the height reference value into the second average function. In this case, the at least one parameter of the calibration function may be calculated using the first and/or second current value. In this context, “current value” can be understood as an ideal value for the current flowing through the electric motor, or for a component of this current, e.g., a d-component or q-component, while assuming ideal friction conditions during the movement of the elevator car.

According to one embodiment, a height-related parameter of the calibration function may be calculated to obtain a height calibration value as the calibration value. Additionally or alternatively, a weight-related parameter of the calibration function may be calculated to obtain a weight calibration value as the calibration value. Additionally or alternatively, a current-related parameter of the calibration function may be calculated to obtain a current calibration value as the calibration value. For example, the height calibration value can have the unit [A/m], the weight calibration value can have the unit [A/kg] and the current calibration value can have the unit [A]. However, other suitable units are also possible. In other words, the adaptation value may be calculated using the height calibration value, the weight calibration value, the current calibration value, or a combination of at least two of the calibration values. In this way, the adaptation value can be calculated very precisely without the elevator car having to be loaded with different weights.

According to one embodiment, the height calibration value may be obtained by forming a mean value from a height-related parameter of the first average function and a height-related parameter of the second average function. In this way, the computing effort required when calculating the height calibration value can be further reduced.

According to one embodiment, the weight calibration value may be obtained by dividing a difference between the first current value and the second current value by a weight value indicating the current mass of the weight. Additionally or alternatively, the current calibration value may be obtained by subtracting a product of the height calibration value and the height reference value from the first current value. The current mass of the weight may be, for example, equal to a nominal mass of the counterweight or equal to a product of a permissible mass of the weight and a predetermined weighting factor. In this way, the computing effort required when calculating the weight calibration value or the current calibration value can be further reduced.

According to one embodiment, the height calibration value may be multiplied by the height reference value, the resulting product is added to the current calibration value and the resulting sum is divided by the weight calibration value to obtain a correction value. The adaptation value can be calculated by adding the correction value to the weight reference value. In this way, the computing effort required when calculating the adaptation value can be further reduced.

According to one embodiment, a check can be made in each time step to see whether the elevator car is moving at a constant speed. In this case, for calculating the at least one parameter of the calibration function, only the current measurement data and/or only the height measurement data from the time steps in which the elevator car is identified as moving at a constant speed can be used. The constant speed of the elevator car can be identified by comparing the speed of the elevator car in a current time step with the speed of the elevator car in at least one time step preceding the current time step. It is also possible for the speed of the elevator car to be identified as being constant when it is identified that the elevator car is moving within a certain height range between the first and second positions. This height range may have been calculated, for example, from known movement parameters of the elevator car, while taking into account the known height difference between the first and second positions, i.e. a simple distance between the first position and the second position. Whether or not the elevator car is in this height range may be identified, for example, by appropriately evaluating the height measurement data. In this way, inaccuracies in the calculation of the adaptation value due to excessive speed changes can be avoided.

According to one embodiment, further control commands for controlling the electric motor can be generated so that the elevator car carries out at least a fifth and sixth test run. In the fifth test run, the elevator car can be moved from the first position to the second position and in the sixth test run, the elevator car can be moved from the second position to the first position, it not being loaded with the weight in either the fifth test run or the sixth test run. Analogously to the method described above, additional current measurement data, which indicate the current measured by means of the current measuring device during the movement of the elevator car, and additional height measurement data, which indicate the height measured by means of the height measuring device during the movement of the elevator car, can be received in a plurality of successive time steps during the fifth and sixth test runs. The additional current measurement data and the additional height measurement data can be used to recalculate at least one parameter of the calibration function to obtain at least one updated calibration value. The adaptation value may then be recalculated using the at least one updated calibration value. In other words, it is possible to recalibrate the elevator system after the initial calculation of one or more calibration values without the elevator car having to be loaded with the weight again. For example, the calculation of the updated calibration value or values may be performed using one or more previously calculated calibration values. For repeated calibration, it is therefore not absolutely necessary for a plurality, or all, of the calibration values to be recalculated. Instead, it is sufficient if only one of the calibration values is recalculated. In this way, the effort required for repeated calibration can be considerably reduced, which significantly simplifies the regular inspection of the elevator system.

For example, it is possible for the first average function to be newly determined using the additional current measurement data and the additional height measurement data to obtain an updated first average function. In this case, the current calibration value can be recalculated using the updated first average function to obtain an updated current calibration value. The adaptation value can then be recalculated using the updated current calibration value together with the height calibration value and the weight calibration value from the test runs preceding the fifth and sixth test runs.

Embodiments of the invention will be described below with reference to the accompanying drawings, wherein neither the drawings nor the description are intended to be interpreted as limiting the invention.

### DESCRIPTION OF THE DRAWINGS

FIG. 1 shows an elevator system according to one embodiment of the invention.

FIG. 2 shows a control device according to one embodiment of the invention.

FIG. 3 is a diagram illustrating various current and speed profiles, which were measured or calculated during the control of the elevator system from FIG. 1.

FIG. 4 shows a flow chart for a method according to one embodiment of the invention.

The drawings are merely schematic, and not to scale. In the different figures, identical reference signs denote identical or similar features.

### DETAILED DESCRIPTION

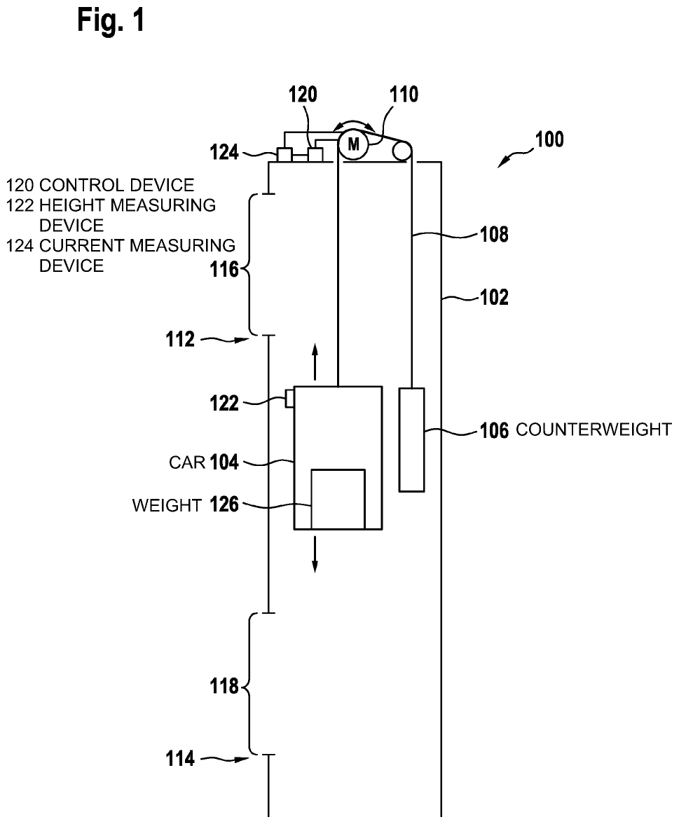

FIG. 1 shows an elevator system 100, for example a passenger or freight elevator in a building, which comprises an elevator shaft 102, an elevator car 104, a counterweight 106, which is coupled to the elevator car 104 via suspension means 108, for example via one or more cables, straps or belts, and an electric motor 110 for driving the suspension means 108, and thus the elevator car 104 or counterweight 106.

The elevator car 104 is moveable along the elevator shaft 102 between a first position 112 and a second position 114. By way of example, in FIG. 1 the first position 112 is a stopping point of the elevator car 104 relative to a first shaft opening 116 in an uppermost story of the building, and the second position 114 is a stopping point of the elevator car 104 relative to a second shaft opening 118 in a lowermost story of the building. Further stopping points of the elevator car 104 can be provided between the two positions 112, 114.

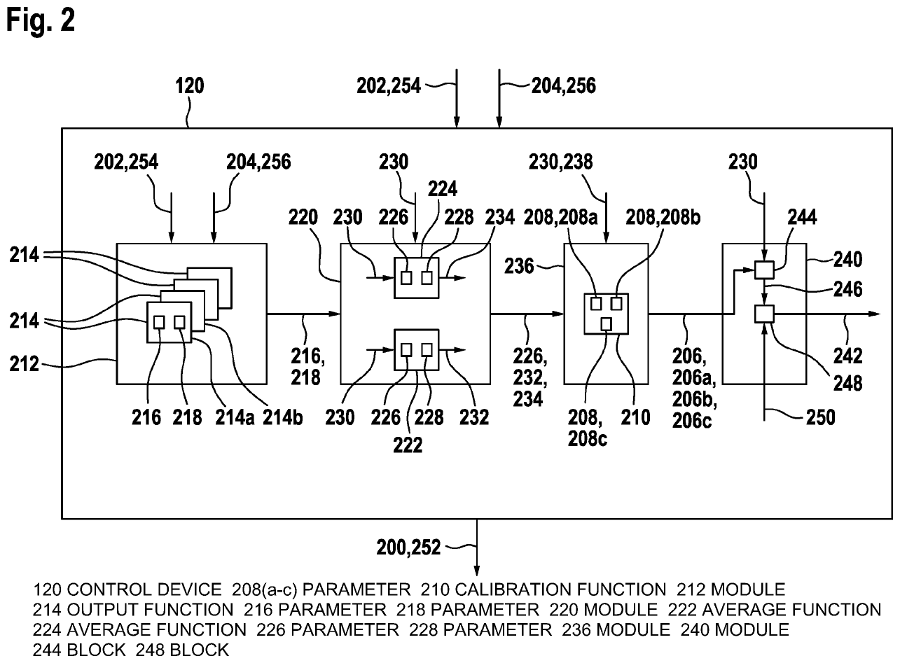

Furthermore, the elevator system 100 comprises a control device 120 for controlling the electric motor 110, as is described in more detail below in reference to FIG. 2.

An input of the control device 120 is connected to an output of a height measuring device 122 that is configured to measure the current height of the elevator car 104 in the elevator shaft 102 relative to the first position 112 and/or to the second position 114. By way of example, the height measuring device 122 in FIG. 1 is configured as an absolute encoder for measuring an absolute position of the elevator car 104 in the elevator shaft 102. However, it is also possible for it to be designed as an incremental encoder or barometer.

The input of the control device 120 is further connected to an output of a current measuring device 124, which is configured to measure the current flowing through the electric motor 110. The current measuring device 124 can be designed, for example, as a component of a controller for regulating a speed of the elevator car 104 and/or as a component of a converter. Contrary to the illustration selected in FIG. 1, the current measuring device 124 can also be designed as a component of the control device 120.

The control device 120 is configured to control the electric motor 110 such that the elevator car 104 performs a series of test runs between the two positions 112, 114 as part of a method that will be described in more detail below. In some of the test runs, the elevator car 104 can be loaded with a weight 126, as shown in FIG. 1.

The individual steps of the method described below for adapting the counterweight 106 are illustrated in the flow chart shown in FIG. 4.

According to the example shown in FIG. 2, in a first step S10 of FIG. 4 the control device 120 generates control commands 200, which prompt the electric motor 110 to raise or lower the elevator car 104 so that the elevator car 104 performs a first, second, third and fourth test run. The test runs can be successively carried out in the sequence indicated. However, another suitable sequence of test runs is also possible. In this case, the elevator car 104 is moved in the first and third test runs from the first position 112 to the second position 114 and in the second and fourth test runs from the second position 114 to the first position 112. In addition, the elevator car 104 is loaded with the weight 126 before the third test run so that the elevator car 104 carries out the third and fourth test runs with the weight 126. In the first and second test runs, however, the elevator car 104 is not loaded.

In each of the aforementioned test runs, in a second step S20, current measurement data 202, which are generated and provided by the current measuring device 124 in a plurality of successive time steps during the movement of the elevator car 104 and height measurement data 204, which are generated and provided by the height measuring device 122 in a plurality of successive time steps during the movement of the elevator car 104, are received in the control device 120 in a plurality of successive time steps.

The current measurement data 202 and the height measurement data 204 are processed in a third step S30 to obtain at least one calibration value 206 that is associated with a parameter 208 of a calibration function 210 that defines a linear relationship between the current flowing through the electric motor 110, the height of the elevator car 104 and a mass of the weight 126.

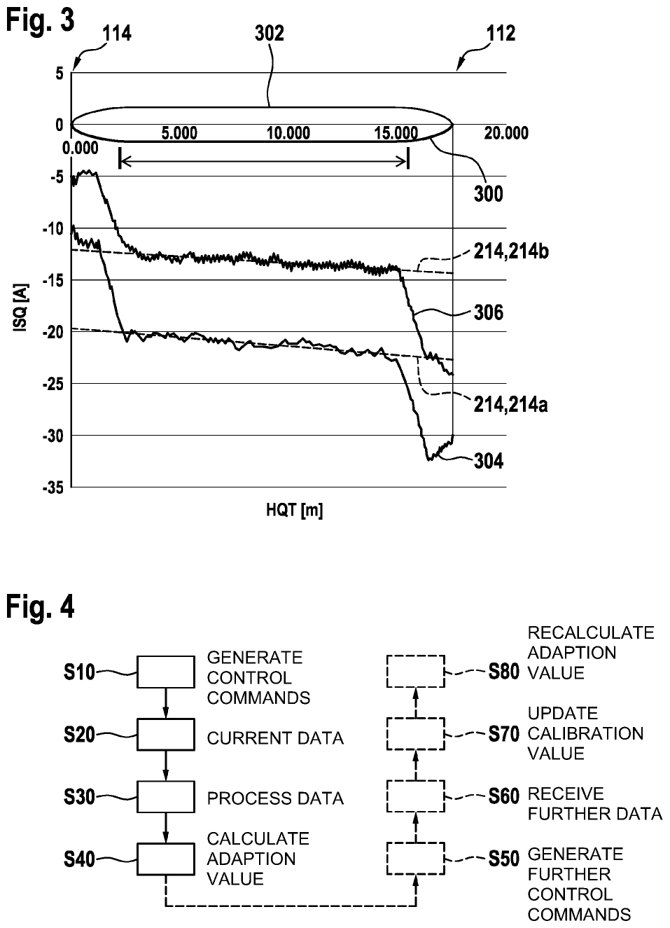

For this purpose, the current measurement data 202 and the height measurement data 204 are input into a first module 212, which determines an output function 214, which defines a linear relationship between the current and the height, for each test run on the basis of the current measurement data 202 and the height measurement data 204 received in different time steps in the relevant test run (see also FIG. 3).

Each output function 214 comprises in this case a first parameter 216 relating to the height and a second parameter 218.

In a second module 220, a first average function 222 and a second average function 224 are determined by correspondingly combining the four output functions 214 obtained, which are likewise linear functions each having a further first height-related parameter 226 and a further second parameter 228.

The further first parameter 226 for the first average function 222 is calculated by forming a mean value from the first parameters 216 of the two output functions 214, which result from the first and second test runs. The further second parameter 228 for the first average function 222 is calculated by forming a mean value from the second parameters 218 of the two output functions 214, which result from the first and second test runs.

By contrast, the further first parameter 226 for the second average function 224 is calculated by forming a mean value from the first parameters 216 of the two output functions 214 resulting from the third and fourth test runs. Similarly, the further second parameter 228 for the second average function 222 is calculated by forming a mean value from the second parameters 218 of the two output functions 214 resulting from the third and fourth test runs.

The second module 220 is further configured to calculate a first current value 232 by inputting a height reference value 230 into the first average function 222 and to calculate a second current value 234 by inputting the height reference value 230 into the second average function 224.

The height reference value 230 was calculated, for example, by halving a height difference between the first position 112 and the second position 114 measured during a previous programming run. However, other methods for calculating the height reference value 230 are also possible.

The calibration value 206 is calculated in a third module 236.

In this example, the third module 236 calculates a height-related parameter 208a of the calibration function 210 to obtain a height calibration value 206a, a weight-related parameter 208b of the calibration function 210 to obtain a weight calibration value 206b, and a current-related parameter 208c of the calibration function 210 to obtain a current calibration value 206c.

The height calibration value 206a is calculated, for example, by forming a mean value from the two further first parameters 226 of the first average function 222 and the second average function 224.

The weight calibration value 206b is calculated, for example, from the two current values 232, 234 and a weight value 238 indicating the mass of the weight 126 by the first current value 232 being subtracted from the second current value 234 and the resulting difference being divided by the weight value 238.

The current calibration value 206c is calculated, for example, from the height calibration value 206a, the height reference value 230 and the first current value 232 by the height calibration value 206a being multiplied by the height reference value 230 and the resulting product being subtracted from the first current value 232.

Finally, in a fourth step S40, an adaptation value 242 is calculated in a fourth module 240 using the calibration value 206 or the calibration values 206a, 206b, 206c, which value indicates how much heavier or lighter the counterweight 106 is supposed to be made so that the elevator car 104 and the counterweight 106 are in equilibrium when the elevator car 104 and the counterweight 106 are at the same height, as shown in FIG. 1.

For this purpose, for example, a correction value 246 is calculated in a first block 244 by the height calibration value 206a being multiplied by the height reference value 230, the resulting product being added to the current calibration value 206c and the resulting sum being divided by the weight calibration value 206b.

Subsequently, for example, in a second block 248, the adaptation value 242 is calculated by adding the correction value 246 to a weight reference value 250.

The weight reference value 250 corresponds, for example, to a product of a permissible mass of the weight 126, i.e., of a nominal load of the elevator car 104, and a predetermined weighting factor that indicates a desired ratio of the counterweight 106 to the nominal load in the balanced state of the elevator system 100.

The control device 120 can be configured-after the initial calculation of the calibration value 206 or the calibration values 206a, 206b, 206c—to generate further control commands 252 in an optional step S50, for example during a regular inspection, by means of which the electric motor 110 is controlled in such a way that the elevator car 104 performs a fifth and sixth test run, wherein the elevator car 104 is moved, for example, from the first position 112 to the second position 114 in the fifth test run and in the opposite direction in the sixth test run. When performing the fifth and sixth test runs, the elevator car 104 no longer needs to be loaded with the weight 126, which considerably reduces the inspection effort.

Analogously to step S20 described above, in an optional step S60 the control device 120 receives further current measurement data 254 from the current measuring device 124 and further height measurement data 256 from the height measuring device 122 in a plurality of successive time steps in the fifth and sixth test runs.

The further measurement data 254, 256 are used in an optional step S70 by the control device 120 to update at least one of the calibration values 206, 206a, 206b, 206c. The further measurement data 254, 256 can be processed in a similar way to that described above with reference to step S30. For example, in this case only the current calibration value 206c may be updated, while the height calibration value 206a and the weight calibration value 206b remain unchanged.

The adaptation value 242 is then recalculated in an optional step S80 by processing the updated calibration value or values together with the non-updated calibration value or values.

FIG. 3 shows, by way of example, in each case as a function of the measured height HQT of the elevator car 104, a first speed profile 300, which indicates the speed of the elevator car 104 in [m/s] during the first test run, a second speed profile 302, which indicates the speed of the elevator car 104 in [m/s] during the second test run, a first current profile 304 of the measured current ISQ that is assigned to the first speed profile 300 and a second current profile 306 of the measured current ISQ that is assigned to the second speed profile 302. In addition, the output functions 214 resulting from the first and second test runs, specifically a first output function 214a resulting from the first test run and a second output function 214b resulting from the second test run, are plotted.

A height range within which the speed of the elevator car 104 is considered to be, or identified as being, constant is marked by a double arrow below profile 300. The height range (HQ_const_speed) is calculated, for example, from the height difference (HG) between the two positions 112, 114, a nominal speed (VKN), a nominal acceleration (AK) and a nominal pressure (JK) of the elevator car 104 as follows:

$$HQ\_const \_speed = HQ - \frac{V K {N}^{2}}{A K} - \frac{VKN \cdot AK}{JK} + \frac{A {K}^{2}}{{JK}^{2}} .$$

If HQ_const_speed≥60%*HQ, then a test speed (v4) at which the elevator car 104 is to be moved during the test runs is set to be equal to the nominal speed. Otherwise, the test speed is calculated, for example, where:

$$v 4 = \frac{A {K}^{2}}{2 \cdot {J}^{K}} \cdot \{ \sqrt{5 + \frac{4 \cdot ( 1 - 0 , 6 ) HQ \cdot {JK}^{2}}{A {K}^{3}}} - 1 \} ,$$

so that HQ_const_speed=60%*HQ.

FIG. 3 shows typical results for HQ_const_speed≥60%*HQ.

An exemplary sequence of a test run will be described below. GQT stands for the current mass of the weight 126 in [kg]. Accordingly, the following applies: GQT=0 kg when the elevator car 104 is unloaded; GQT=GQ if the current mass of the weight 126 is equal to the permissible mass GQ of the weight 126. Furthermore, the following applies: HQT=0 m when the elevator car 104 is in the second position 114, i.e. in the lowermost story; HQT=HQ when the elevator car 104 is in the first position 112, i.e. in the uppermost story.

First, the weight value 238 is input via a user interface, i.e. GQT_test1=0 for the first and second test runs, and for the third and fourth test runs, for example, GQT_test2=GQ or GQT_test2≈GQ.

Thereupon, the control device 120 requests a current converter current iq from the converter, which current is regularly communicated to the control device 120 at certain time intervals, for example every 10 ms, during the remaining course of the method.

The test run then starts according to the selected test speed.

As soon as it is identified that the elevator car 104 is moving within the height range HQ_const_speed, a linear regression is started based on the current measurement data 202 or 254 and the height measurement data 204 or 256, wherein the results of the linear regression are updated in each time step, i.e. for example every 10 ms.

As soon as it is detected that the elevator car 104 is no longer moving within the height range HQ_const_speed, the linear regression is aborted.

From the regression results obtained up to the time of the interruption, the first parameter 216 and the second parameter 218 of the relevant output function 214 are calculated at the end of the test run.

The following four output functions 214 result from the first through fourth test runs:
for the first test run:

$$ISQ\_test1 \_down ( HQT , GQT = GQT\_test1 ) = a\_test1 \_down ⋆ HQT + b\_test1 \_down ;$$

for the second test run:

$$ISQ\_test1 \_up ( HQT , GQT = GQT\_test1 ) = a\_test1 \_up * HQT + b\_test1 \_up ;$$

for the third test run:

$$ISQ\_test2 \_down ( HQT , GQT = GQT\_test2 ) = a\_test2 \_down * HQT + b\_test2 \_down ;$$

for the fourth test run:

$$ISQ\_test2 \_up ( HQT , GQT = GQT\_test1 ) = a\_test2 \_up * HQT + b\_test2 \_up .$$

Here, a_test1_down, a_test1_up, a_test2_down and a_test2_up each denote the first parameter 216 and b_test1_down, b_test1_up, b_test2_down and b_test2_up each denote the second parameter 218 of the relevant output function 214.

From these results, the control device 120 calculates the three calibration values a_HQT, b_GQT and ISQ0 and permanently stores them. In this case, a_HQT denotes the height calibration value 206a, b_GQT denotes the weight calibration value 206b and ISQ0 denotes the current calibration value 206c.

It is assumed here that the same, i.e. ideal, frictional conditions apply for both directions of movement of the elevator car 104. Under this assumption, the current, more precisely a q-component of the current (ISQ_no_friction) used for controlling a torque of the electric motor 110, can be calculated as follows:
with the aid of the first average function 222:

$$ISQ\_no \_friction \_test1 ( HQT , GQT = GQT\_test1 ) = a\_test1 * HQT + b\_test1 ;$$

with the aid of the second average function 224:

$$ISQ\_no \_friction \_test2 ( HQT , GQT = GQT\_test2 ) = a\_test2 * HQT + b\_test2 .$$

The following applies:

$$a\_test 1 = ( a\_test1 \_down + a\_test1 \_up ) / 2 ;$$

$$b\_test 1 = ( b\_test1 \_down + b\_test1 \_up ) / 2 ;$$

$$a\_test2 = ( a\_test2 \_down + a\_test2 \_up ) / 2 ;$$

$$b\_test 2 = ( b\_test2 \_down + b\_test2 \_up ) / 2.$$

Here, a_test1 and a_test2 denote the further first parameters 226, and b_test1 and b_test2 denote the further second parameters 228.

a_test1 and a_test2 are ideally identical and depend only on HQT, while b_test1 and b_test2 are not dependent on HQT, but instead only on GQT.

The calibration function 210 accordingly reads as:

$$ISQ\_no \_friction ( HQT , GQT ) = a\_HQT * HQT + b\_GQT * GQT + ISQ 0 ,$$

with a_HQT in [A/m], b_GQT in [A/kg] and ISQ0 in [A].

a_HQT is independent of GQT. Because a_test1 and a_test2 are based on mutually independent measurements, a_HQT can easily be calculated with:

$$a\_HQT = ( a\_test1 + a\_test2 ) / 2.$$

b_HQT and ISQ0 can be calculated with the following equation system:

$$ISQ\_no \_friction \_test1 ( HQT = HQ / 2 , \text{} GQT = GQT\_test1 ) = a\_HQT * HQ / 2 + b\_GQT ⋆ GQT\_test 1 \text{} + ISQ 0 ;$$

$$ISQ\_no \_friction \_test2 ( HQT = HQ / 2 , GQT = GQT\_test2 ) = a\_HQT ⋆ HQ / 2 + b\_GQT ⋆ GQT\_test2 + ISQ 0.$$

b_GQT yields:

$$b\_GQT = [ ISQ\_no \_friction \_test2 ( HQT = HQ / 2 , GQT = GQT\_test2 ) - \text{} I SQ\_no \_friction \_test1 ( HQT = HQ / 2 , GQT = GQT\_test1 ) ] \text{} / [ \text{} GQT\_test2 - GQT\_test1 ] .$$

ISQ0 yields:

$$ISQ 0 = ISQ\_no \_friction \_test1 ( HQT = HQ / 2 , GQT = GQT\_test1 ) - a\_HQT ⋆ HQ / 2 - b\_GQT * GQT\_test 1.$$

The values a_HQT, b_GQT and ISQ0 are permanently stored in memory.

For the calculations described below, the following applies:
KG_nom: desired compensation factor in percent;
KG_act: existing compensation factor in percent.

The elevator system 100 can be assumed to be balanced if the following applies: ISQ_no_friction(HQT=HQ/2, GQT)=0.

From this:

$$ISQ\_no \_friction ( HQT = HQ / 2 , GQT ) = a\_HQT * HQ / 2 + b\_GQT * GQT\_balanced + ISQ 0 = 0 ;$$

$$GQT\_balanced = - [ a\_HQT * HQ / 2 + ISQ 0 ] / b\_GQT .$$

The existing compensation factor is calculated as follows:

$$KG\_act [ \% ] = 100 * GQT\_balanced / GQ = - 100 * [ a\_HQT * HQ / 2 + ISQ 0 ] / b\_GQT / GQ .$$

The compensating weight (Delta_GQ), which is to be added to the counterweight 106 or is to be taken away therefrom so that the elevator system 100 is balanced, is ultimately calculated with:

$$Delta\_GQ [ kg ] = ( KG\_nom - KG\_act ) * 0.01 ⋆ GQ = KG\_nom * 0.01 * GQ + ( a\_HQT * HQ / 2 + ISQ 0 ) / b\_GQT .$$

Delta_GQ hereby refers to the adaptation value 242.

If Delta_GQ>0, then the compensating weight Delta_GQ is to be added to the counterweight 106. If Delta_GQ<0, then the compensating weight Delta_GQ is to be removed from the counterweight 106.

In future compensation tests, the elevator car 104 needs to be moved only in the unloaded state, because a_HQT and b_GQT remain the same, irrespective of the current weight adjustment.

For this purpose, the following parameters are recalculated, for example, on the basis of the further current measurement data 254 and the further height measurement data 256 of the fifth and sixth test runs (see further above):

$$ISQ\_no \_friction \_test1 ( HQT , HQT = GQT\_test1 ) = a\_test1 * HQT + b\_test1 ;$$

$$where : a\_test1 = ( a\_test1 \_down + a\_test1 \_up ) / 2 ;$$

$$b\_test1 = ( b\_test1 \_down + b\_test1 \_up ) / 2.$$

ISQ0 is recalculated as follows:

### With GQT_test1=0:

$$ISQ 0 = ISQ\_no \_friction \_test1 ( HQT = HQ / 2 , GQT = GQT\_test1 ) - a\_HQT * HQ / 2 - b\_GQT * GQT\_test1 = ( a\_test1 - a\_HQT ) * HQ / 2 + b\_test1 - b\_GQT * GQT\_test1 .$$

ISQ0 is permanently stored and a_HQT and b_GQT remain unchanged.

The calculations for KG_act and Delta_GQ described above are then repeated with the updated value of ISQ0.

Finally, it should be noted that terms such as “comprising,” “including,” etc. do not exclude other elements or steps, and terms such as “a” or “one” do not exclude a plurality. Furthermore, it should be noted that features or steps that have been described with reference to one of the above embodiments can also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for adapting a counterweight of an elevator system, the elevator system having an elevator shaft, an elevator car movable along the elevator shaft at least between a first position and a second position, the elevator car being coupled to the counterweight via suspension means, and an electric motor driving the suspension means thereby moving the elevator car, the method comprising steps of:
generating control commands to control the electric motor such that the elevator car performs at least a first test run, a second test run, a third test run and a fourth test run;
moving the elevator car from the first position to the second position during each of the first test run and the third test run and moving the elevator car from the second position to the first position during each of the second test run and the fourth test run;
wherein the elevator car is loaded with a weight during the third test run and the fourth test run and is not loaded with the weight during the first test run and the second test run;
receiving from a current measurement device, during the movement of the elevator car, current measurement data indicating a current flowing through the electric motor and receiving from a height measuring device, during the movement of the elevator car, height measurement data indicating a height of the elevator car relative to the first position and/or to the second position in a plurality of successive time steps during each of the first through fourth test runs;
calculating at least one parameter of a calibration function, the calibration function defining a relationship among the current, the height and the weight, using the current measurement data and the height measurement data received during different ones of the test runs, to obtain at least one calibration value; and
calculating an adaptation value using the at least one calibration value, the adaptation value enabling adaptation of the counterweight to be in equilibrium with the elevator car.

17. The method according to claim 16 including:
calculating a height reference value by halving a height difference between the first position and the second position; and/or
calculating a weight reference value by multiplying a permitted mass of the weight by a predetermined weighting factor; and
calculating the adaptation value using the height reference value and/or the weight reference value.

18. The method according to claim 16 including:
determining a first average function that defines a first relationship between the current and the height, while assuming ideal frictional conditions, using the current measurement data and the height measurement data received during the first test run and the second test run; and/or
determining a second average function that defines a second relationship between the current and the height, while assuming the ideal frictional conditions, using the current measurement data and the height measurement data received during the third test run and the fourth test run; and
calculating the at least one parameter of the calibration function using the first average function and/or the second average function.

19. The method according to claim 18 including:
determining for each of the first through fourth test runs an associated output function defining a linear relationship between the current and the height, each of the output functions being determined by processing the current measurement data and the height measurement data that were received in the different time steps during the associated test run of the first through fourth test runs; and
calculating at least one parameter of the first average function by forming a mean value from a parameter of the output function associated with the first test run and a parameter of the output function associated with the second test run; and/or
calculating at least one parameter of the second average function by forming a mean value from a parameter of the output function associated with the third test run and a parameter of the output function associated with the fourth test run.

20. The method according to claim 18 including:
calculating a height reference value by halving a height difference between the first position and the second position;
calculating a first current value by inputting the height reference value into the first average function; and/or
calculating a second current value by inputting the height reference value into the second average function; and
calculating the at least one parameter of the calibration function using the first current value and/or the second current value.

21. The method according to claim 16 including:
calculating a height-related parameter of the calibration function to obtain a height calibration value as the at least one calibration value; and/or
calculating a weight-related parameter of the calibration function to obtain a weight calibration value as the at least one calibration value; and/or
calculating a current-related parameter of the calibration function to obtain a current calibration value as the at least one calibration value.

22. The method according to claim 21 including:
determining a first average function that defines a first relationship between the current and the height, while assuming ideal frictional conditions, using the current measurement data and the height measurement data received during the first test run and the second test run;
determining a second average function that defines a second relationship between the current and the height, while assuming the ideal frictional conditions, using the current measurement data and the height measurement data received during the third test run and the fourth test run; and
obtaining the height calibration value by forming a mean value from a height-related parameter of the first average function and a height-related parameter of the second average function.

23. The method according to claim 22 Including:
calculating a height reference value by halving a height difference between the first position and the second position;
calculating a first current value by inputting the height reference value into the first average function;
calculating a second current value by inputting the height reference value into the second average function;
obtaining the weight calibration value by dividing a difference between the first current value and the second current value by a weight value indicating a current mass of the weight; and/or
obtaining the current calibration value by subtracting a product of the height calibration value and the height reference value from the first current value.

24. The method according to claim 23 including:
obtaining a correction value by multiplying the height calibration value by the height reference value, adding a resulting product of the multiplication to the current calibration value, and dividing a resulting sum of the addition by the weight calibration value; and
calculating the adaptation value by adding the correction value to the weight reference value.

25. The method according to claim 16 including:
checking, in each of the time steps, whether the elevator car is moving at a constant speed; and
calculating the at least one parameter of the calibration function only using the current measurement data and/or the height measurement data from the time steps in which the elevator car is moving at the constant speed.

26. The method according to claim 16 including:
generating further control commands to control the electric motor such that the elevator car performs a fifth test run and a sixth test run;
moving the elevator car from the first position to the second position during the fifth test run and moving the elevator car from the second position to the first position during the sixth test run, wherein the elevator car is not loaded with the weight during the fifth test run and the sixth test run;
receiving from the current measurement device, during the movement of the elevator car, further current measurement data indicating a current flowing through the electric motor, and receiving from the height measurement device, during the movement of the elevator car, further height measurement data indicating a height of the elevator car in a plurality of successive time steps during each of the fifth test run and the sixth test run;
recalculating the at least one parameter of the calibration function using the further current measurement data and the further height measurement data to obtain at least one updated calibration value; and
recalculating the adaptation value using the at least one updated calibration value, the recalculated adaptation value enabling adaptation of the counterweight to be in equilibrium with the elevator car.

27. A control device for an elevator system, the control device comprising a processor adapted to control the elevator system to carry out the method according to claim 16.

28. An elevator system comprising:
an elevator shaft;
an elevator car movable along the elevator shaft between a first position and a second position;
a counterweight coupled to the elevator car via a suspension means;
an electric motor driving the suspension means to move the elevator car and the counterweight in the elevator shaft;
a current measuring device measuring a current flowing through the electric motor;
a height measuring device measuring a height of the elevator car relative to the first position and/or the second position; and
a control device according to claim 27.

29. A computer program product comprising non-transitory commands that prompt a processor to carry out the method according to claim 16 when the commands are executed by a computer processor.

30. A non-transitory computer-readable medium having a set of computer readable instructions stored thereon, wherein the instructions, when executed by a computer processor, carry out the method according to claim 16.
